(19) United States
(12) Patent Application Publication
(10) Pub. No.: US 2003/0068402 A1
(43) Pub. Date: Apr. 10, 2003

(54) Injection mould and ejector arrangement therefor

(76) Inventor: Lars Persson, Kristianstad (SE)

Correspondence Address: BENTON S. DUFFETT, JR., BURNS, DOANE, SWECKER & MATHIS, L.L.P., P.O. Box 1404, Alexandria, VA, 22313-1404, US

(21) Appl. No.: 10/036,376

(22) Filed: Jan. 7, 2002

(30) Foreign Application Priority Data
Oct. 10, 2001 (SE) 0103378-6

(51) Int. Cl. B29C 45/40

(52) U.S. Cl. 425/556

(57) ABSTRACT

The invention relates to an injection mold having an ejector arrangement (1) comprising ejectors (7) which, in parting of mold halves (2a, 2b) included in the mold, are adapted to eject a component (15) formed therein, and a pressure plate (30) for actuation of the ejectors (7). The mold is characterised in that the ejectors (7) in their non-actuated state are completely, or essentially completely, received in ducts (3) formed in a first of said mold halves (2a). The pressure plate (30) has press pins (31) which, in parting of the mold halves (2a, 2b), are adapted to apply a force to the ejectors (7) to cause said ejection. The invention also concerns an ejector arrangement of an injection mold having such features, and an injection mold made up of modules.

### FIELD OF THE INVENTION

The present invention relates to an injection mould which has as en ejector arrangement comprising ejectors which, in parting of mould halves included in the mould, are adapted to eject a component formed therein, and a pressure plate for actuating the ejectors. The invention also relates to an ejector arrangement of an injection mould and an injection mould made up of modules.

### BACKGROUND ART

In the plastics trade there is a continuous aim to make smaller and smaller thicknesses since a small thickness requires less material and, above all, results in more rapid cooling of the components and, thus, a higher production rate. However, making small thicknesses necessitates very high pressures for the melt to be pressed out in the entire cavity. With today's injection moulds, however, a turning point has been reached since the moulds tend to be too pliable. A factor contributing to the pliancy of the mould is the conventional ejector arrangements that are used.

Conventional ejector arrangements are arranged in one mould half and comprise a pressure plate which is adapted to act in a space formed as a recess in the rear side of the mould half. The recess causes a considerable weakening of the mould half since the wall portion just behind the cavity will be too weak to counteract deformations that are produced by the high moulding pressure. The high pressures that are necessary in injection moulding of thin-walled material in fact result in elastic deformation in the form of deflection of the wall portion behind in the first place the cavity since the posteriorly situated wall portion, owing to the recess, is not sufficiently stable.

To increase the rigidity of the mould half, the wall thickness behind the cavity can be increased, but such a solution causes another type of deformation which is rather to be considered an elastic deformation of the entire mould half rather than elastic deflection.

Naturally, the deformation of the mould half affects the dimensional accuracy of the components and above all their surface quality, as will be explained below.

As the injected melt solidifies, natural shrinkage occurs. The shrinkage is volumetrically non-uniform seen over the surface area of the component, which results in different contact pressure between the surface of the component and the surface of the cavity. The pressure-related deformation of the cavity reinforces the effect of the non-uniform distribution of the contact pressure. For instance, this means that the surface texture of the cavity is not transferred as an exact cast to the surface of the component, which in turn results in visual surface defects on the component in the form of uneven light refraction and patchiness.

The two pressure-related types of deformation described above are difficult for a mould designer to predict, which means that there will often be a balancing between increasing the wall thickness of the mould half and introducing pure dimensional compensations into the cavity. The work of fitting to achieve dimensionally correct components and components with acceptable surface quality will therefore in many cases be extensive.

### OBJECTS OF THE PRESENT INVENTION

An object of the present invention is to provide an improved injection mould, which is less sensitive to pressure-related deformation.

Another object of the invention is that the lower degree of sensitivity to deformation is to be achieved without supplying additional material.

One more object of the invention is that it should be easy to manufacture, mount and maintain the injection mould.

### SUMMARY OF THE INVENTION

According to the present invention, the above objects and also further objects that have not been stated will be achieved by an injection mould having the features stated in claim 1. Preferred embodiments are evident from claims 2-7. The invention also concerns according to claim 8 an ejector arrangement having such features and, according to claim 9, an injection mould made up of modules. Preferred embodiments of the injection mould made up of modules are evident from claim 10.

More specifically, an injection mould is provided which has an ejector arrangement comprising ejectors which, in parting of the mould halves included in the mould, are adapted to eject a component formed therein, and a pressure plate for actuating the ejectors. The mould is characterised in that the ejectors in their non-actuated state are completely, or essentially completely, received in ducts formed in a first of said mould halves and that the pressure plate has press pins which, in parting of the mould halves, are adapted to apply a force to the ejectors to cause said ejection.

The invention with the above-described features provides an injection mould which significantly reduces the problems with pressure-related elastic deformation and deflection of the mould half. In fact the mould half can be formed without an inner cavity or a recess, and the thickness of the wall portion behind the cavity can be optimised. The cavity has a posteriorly situated wall portion of uniform thickness, which efficiently counteracts on the one hand the pressure-related deflection and, on the other hand, the total resulting deformation of the mould and its mould half. This increases the dimensional correctness of the components. By the cavity being less sensitive to pressure-related deflection and deformation, a more uniform contact pressure between the component and the cavity is achieved. As a result, a better and more precise cast of the surface texture of the cavity is obtained. Thus, the process of fitting the mould is simplified to a considerable extent, which in the end results in components of improved quality, thinner wall thickness and lower unit cost per component produced.

It is preferred for the ejectors along their entire, or essentially entire, length to be accommodated in the ducts. This gives good guiding of their axial motion.

According to a preferred embodiment, the end of each ejector facing the pressure plate has a profile that allows non-rotational anchoring for cooperation with a complementary profile arranged in a locking plate, thereby preventing the ejector from being turned. The profile can be, for instance, non-rotationally symmetrical.

It is also preferred for the end of each ejector facing the component to form part of the boundary surface of the cavity. By the ejector being prevented from turning relative to the locking plate, the orientation of the ejector relative to the component will be retained. Thus the ejectors can be arranged to engage the surface of a component at any point, without the mould designer being obliged to find a surface on the component which is quite flat or even perpendicular to the parting direction of the mould. Moreover the locking plate holds the ejectors in place inside the mould half and prevents the ejectors from falling out of the mould half while being handled.

Moreover, it is preferred for the ducts to comprise resetting means for resetting the position of the ejectors after actuation. The resetting means can be designed in many different ways, but preferably consist of springs.

According to another aspect, the invention concerns an ejector arrangement of an injection mould, comprising ejectors which, in parting of mould halves included in the mould, are adapted to eject a component formed therein, and a pressure plate for actuation of the ejectors. The ejector arrangement is characterised in that the ejectors in their non-actuated state are completely, or essentially completely, received in ducts formed in the mould, and that the pressure plate has press pins which, in parting of the mould halves, are adapted to apply a force to the ejectors to cause said ejection.

In a preferred embodiment, the injection mould is made up of modules, comprising a mould module having a cavity, an ejector module accommodating ejectors and resetting means, a module comprising the locking plate, and a module comprising the pressure plate. To divide the mould into modules is very advantageous since it is easier to handle a number of modules than one large mould during, for instance, mould fitting, mould exchange or mould maintenance.

According to another preferred embodiment of the injection mould made up of modules, the ejectors are in their non-actuated state essentially received in ducts formed in the mould module and the ejector module. The pressure plate also has press pins which, in parting of the mould, are adapted to apply a force to the ejectors to cause said ejection.

### DESCRIPTION OF DRAWINGS

The invention will now be described in more detail by way of example and with reference to the accompanying drawings which illustrate a currently preferred embodiment.

FIGS. 1a-1b are a schematic cross-sectional view of a mould half comprising an ejector arrangement according to a preferred embodiment of the present invention in a closed and an open state, respectively.

FIG. 2 is a schematic cross-sectional view of a mould half comprising an injector arrangement as part of an injection mould made up of modules.

### TECHNICAL DESCRIPTION

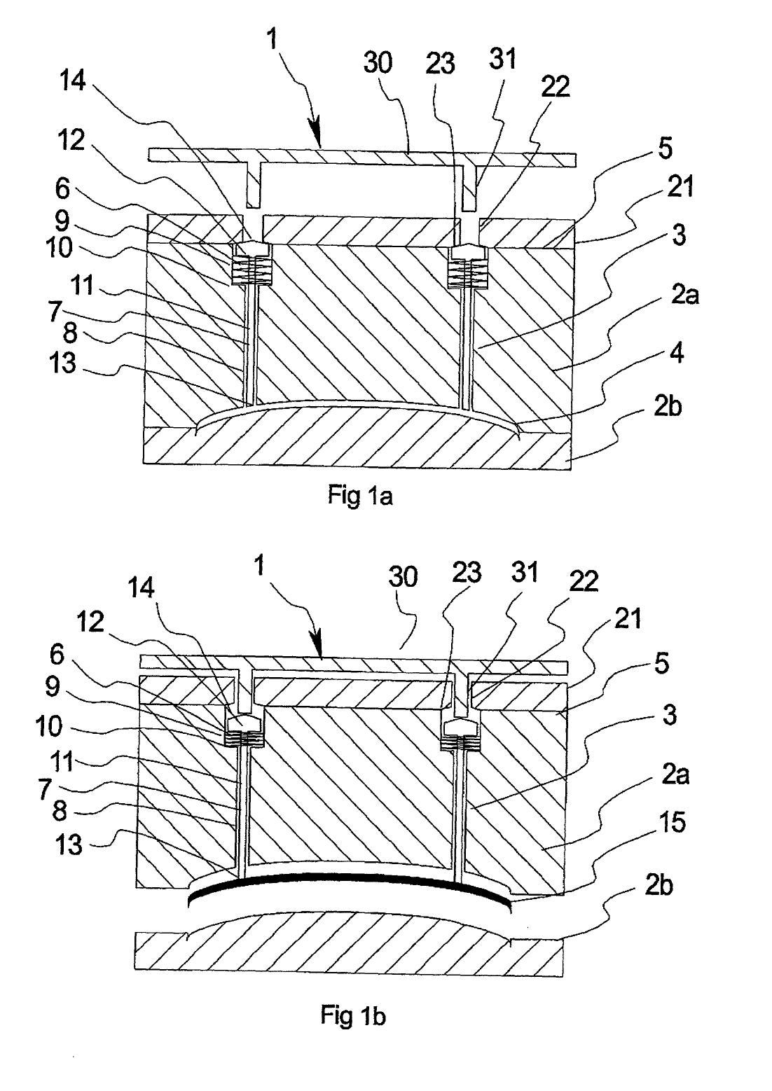

FIG. 1a and FIG. 1b illustrate schematically an ejector arrangement 1 mounted in a mould half 2a according to a preferred embodiment of the present invention.

In the description, “front side” relates throughout to the side of the mould half 2a facing its cavity 4 and, correspondingly, “rear side” relates to the side of the mould half facing away from the cavity.

The mould half 2a has ejector-receiving ducts 3 which extend between the cavity 4 and the rear side 5 of the mould half 2a. The geometry of the ducts 3 is adjusted to the selection of resetting means 6 and to the geometry of the ejectors 7. The duct 3 that will be described below is intended for the most preferred embodiment of ejectors 7 and resetting means 6. However, what is essential to the invention is that the ejector 7 along its entire, or essentially entire, length is received in the duct 3.

Each duct 3 is divided into two portions 8, 9 having a first and a second diameter respectively. The front portion 8 having the first diameter is adjusted to the diameter of the ejector 7 and is intended to provide axial guiding of the ejector. The rear portion 9 is as regards diameter somewhat larger than the diameter of the ejector 7 and is intended to accommodate the resetting means 6 in the form of a coil spring. The transition between the two portions 8, 9 forms a natural contact surface 10 for a front end of the coil spring. For the sake of clarity, the figures show an exaggerated play between the diameter of the duct 3 and the diameter of the ejector 7. For the ejector 7 to obtain good guiding inside the duct 3, this play should reasonably be small.

It will be appreciated that the geometry of the ejector 7 is adjusted to, for instance, the choice of resetting means 6.

The ejector 7 consists in its simplest form of an elongate pin 11 which at its rear end is provided with a head 12. The front end of the head 12 is adjusted so as to form a contact surface with the rear end of the coil spring. The head 12 has such a geometry that it can rest in and obtain guiding of the rear portion 9 of the duct 3. The rear side 14 of the head 12 has preferably a non-rotationally symmetrical end profile. Alternatively, the circumferential surface of the head 12 can be made non-rotationally symmetrical. The primary thing is, however, that the ejector 7 should obtain a non-rotational anchoring by means of a locking plate, as will be described below.

The front end 13 of the ejector 7 has preferably a profile so as to form part of the boundary surface of the cavity.

The rear side 5 of the mould half 2a is covered by a locking plate 21. The locking plate 21 is mounted on the mould half 2a in a suitable manner by means of, for instance, bolts (not shown). The primary purpose of the locking plate 21 is to form a cover which prevents the ejectors 7 and the resetting means 6 from falling out of the mould half 2a while being handled. The locking plate 21 is formed with through ducts 22 which are arranged concentrically with the ducts 3 of the mould half 2a. The ducts 22 of the locking plate 21 are intended to cooperate with a pressure plate 30 and its press pins 31 insertable therein, as will be described below. On the front side of the locking plate 21 the duct openings 23 are recessed with a geometry complementary to the heads 12 of the ejectors 7. As a result, the ejectors 7 are non-rotationally anchored, which is important in the cases where the front end 13 of the ejectors 7 is formed according to the surface of the component 15 to form part of the boundary surface of the cavity.

As mentioned above, the ejectors 7 are actuated by means of a pressure plate 21. The pressure plate 30 comprises in its simplest embodiment a plate having press pins 31 which are concentrically arranged with the ducts 22, 3 in the locking plate 21 and the mould half 2a, respectively. The press pins 31 have a cross-sectional geometry corresponding to the ducts 22 of the locking plate 21. The length of the press pins 31 determines the stroke of the ejectors 7.

Depending on how the injection mould and the injection moulding assembly are designed, the pressure plate 30 can be either fixedly or movingly arranged in relation to the mould half 2a. With reference to FIG. 1b, the mould half 2a comprising the ejectors 7 and the locking plate 21 is in the preferred embodiment movingly mounted in relation to the pressure plate 30. When parting the mould halves 2a, 2b for exposing a component 15, one mould half 2a and its locking plate 21 are thus moved toward the pressure plate 30. This results in the locking plate 21 and the mould half 2a being pressed axially over the press pins 31 of the pressure plate 30, whereby the press pins engage the heads 12 of the ejectors 7 and press the ejectors 7 into the cavity 4, where the front ends 13 of the ejectors 7 engage the component 15 formed therein. By the front ends 13 of the ejectors 7 being designed according to the surface of the component 15, a maximum contact surface between ejector 7 and component 15 is obtained, which causes even and stable ejection of the component.

When the component 15 has been ejected and removed from the cavity 4, the mould half 2a makes a return motion, which means that the press pins 31 relieve the pressure on the ejectors 7. The resetting means 6 return, with the pressure relieved, the ejectors 7 to their initial position.

It goes without saying that resetting can be achieved in various ways, and how resetting occurs is less important to the invention as such. The simplest variant is, as described above, coil springs. The resetting can also take place, for instance, pneumaticcally, which causes necessary adaptations of, among other things, the ejectors and the ducts.

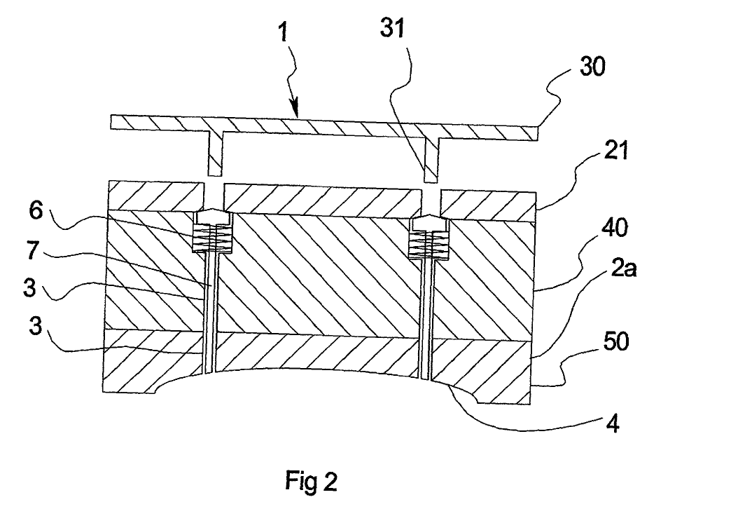

In the embodiment described above, the ejector arrangement 1 is built into a conventional mould for injection moulding. The ejector arrangement 1 is also suited for use in a mould made up of modules, which in a well preferred embodiment will be described below with reference to FIG. 2.

The first module, the mould module 50, consists in this case of one mould half 2a which merely contains the material that is necessary to form the cavity 4 with sufficient stability. This first module has ducts 3 for accommodating the ejectors 7.

The second module, the ejector module 40, consists of a block of uniform thickness, with ducts 3 for accommodating the ejectors 7 and their resetting means 6. The ducts 3, the ejectors 7 and the resetting means 6 are formed according to the description above. The ejector module 40 can also advantageously comprise means for slider mechanisms or cooling (not shown).

The locking plate 21 and the pressure plate 30 with its press pins 31 constitute, like before, separate modules and are also formed according to the description above.

The ejector module 40 and the locking plate 21 mounted thereon together constitute a compact unit which can be handled as a separate unit in relation to the mould module 50 and the pressure plate 30 respectively.

Arranged in an assembly for injection moulding, the ejector module 40 and the locking plate 21 are fixedly mounted on the rear side of the mould module 50 and form, together with the same, a unit which is movable in relation to the pressure plate 30. The function of the arrangement is otherwise the same as described above and will therefore not be described once more.

It will be appreciated that the ejectors need not be arranged to act perpendicularly to the parting plane of the mould halves. For instance, for exposing undercut surfaces, the ejectors can be arranged to act at a certain angle relative to the parting plane of the mould halves.

A mould which is thus made up of modules gives a number of advantages. By the mould being formed of a number of modules which each can be handled separately, the mould will be very easy to handle in connection with, for instance, mould exchange and mould maintenance. Moreover the fitting of the mould will be facilitated significantly since individual modules can be exchanged or readjusted separately. It is also possible to make the different modules of the mould in parallel, which reduces the total time expenditure for the making of moulds.

Summing up, the invention provides an ejector arrangement 1 which, as regards design, is very inelastic. The inelasticity in combination with the absence of a recess for guiding a pressure plate causes the mould half 2a to be less sensitive to deformations of the cavity 4 and the mould half 2a which are usually associated with conventional ejector arrangements. As a result, the components 15 produced in the mould will obtain greater dimensional accuracy and the work with fitting of the mould will be simplified. By the mould half 2a, owing to the absence of the recess, being of uniform thickness and, thus, less sensitive to deformation, a more uniform contact pressure is obtained between cavity and component during injection moulding, which results in a better cast of the surface texture of the cavity. Thus, the ejector arrangement enables production of components having a small wall thickness and high and even dimensional accuracy as well as surface quality.

The ejector arrangement 1 comprises a locking plate 21 which on the one hand prevents the ejectors 7 and the resetting means 6 from falling out of the mould half 2a while being handled and, on the other hand, non-rotationally secures the ejectors 7 in the mould half 2a. The latter is an important feature in the cases where the front end 13 of the ejectors 7 is formed with a profile for forming a boundary surface in the cavity 4.

It will be appreciated that the present invention is not restricted to the shown embodiment of the inventive injection mould. Several modifications and variants are thus feasible, and, consequently, the invention is defined exclusively by the appended claims.

1. An injection mould which has an ejector arrangement (1) comprising
ejectors (7) which, in parting of mould halves (2a, 2b) included in the mould, are adapted to eject a component (15) formed therein, and
a pressure plate (30) for actuating the ejectors (7), characterised in that
the ejectors (7) in their non-actuated state are completely, or essentially completely, received in ducts (3) formed in a first of said mould halves (2a) and
the pressure plate (30) has press pins (31) which, in parting of the mould halves (2a, 2b), are adapted to apply a force to the ejectors (7) to cause said ejection.

2. An injection mould as claimed in claim 1, in which the end of each ejector (7) facing the pressure plate (30) has a profile that allows non-rotational anchoring for cooperation with a complementary profile arranged in a locking plate (21), thereby preventing the ejector (7) from being turned.

3. An injection mould as claimed in claim 2, in which the end of each ejector (7) facing the pressure plate (30) has a non-rotationally symmetrical profile.

4. An injection mould as claimed in claim 1, in which the duct (3) extends from a cavity (4) arranged in the mould and through the locking plate (21).

5. An injection mould as claimed in claim 1, in which the ducts (3) accommodate resetting means (6) for resetting the position of the ejectors after actuation.

6. An injection mould as claimed in claim 5, in which the resetting means (6) consist of springs.

7. An injection mould as claimed in claim 1, in which the end of each ejector (7) facing the component (15) forms part of the boundary surface of the cavity (4).

8. An injector arrangement (1) of an injection mould, comprising
ejectors (7) which, in parting of mould halves (2a, 2b) included in the mould, are adapted to eject a component (15) formed therein, and
a pressure plate (30) for actuation of the ejectors (7), characterised in that
the ejectors (7) in their non-actuated state are completely, or essentially completely, received in ducts (3) formed in the mould, and
the pressure plate (30) has press pins (31) which, in parting of the mould halves (2a, 2b), are adapted to apply a force to the ejectors (7) to cause said ejection.

9. An injection mould, characterised in that
it is made up of modules, comprising a mould module (50) having a cavity (4), an ejector module (40) accommodating ejectors (7) and resetting means (6), a module comprising the locking plate (21), and a module comprising the pressure plate (30).

10. An injection mould as claimed in claim 9, in which the ejectors (7) in their non-actuated state are essentially received in ducts (3) formed in the mould module (50) and the ejector module (40, and
the pressure plate (30) has press pins (31) which, in parting of the mould, are adapted to apply a force to the ejectors (7) to cause said ejection.
